(19) United States
(12) Patent Application Publication
(10) Pub. No.: US 2007/0106501 A1
(43) Pub. Date: May 10, 2007

(54) System and method for subvocal interactions in radiology dictation and UI commands

(75) Inventors: Mark M. Morita, Arlington Heights, IL (US); Prakash Mahesh, Schaumburg, IL (US); Thomas A. Gentles, Algonquin, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/268,240

(22) Filed: Nov. 7, 2005

(51) Int. Cl. G10L 11/00

(52) U.S. Cl. 704/200

(57) ABSTRACT

Certain embodiments of the present invention provide a medical workflow system including a subvocal input device, an impulse processing component, and an information management system. The subvocal input device is capable of sensing nerve impulses in a user. The impulse processing component is in communication with the subvocal input device. The impulse processing component is capable of interpreting nerve impulses as dictation data and/or a command. The information management system is in communication with the impulse processing component. The information management system is capable of processing dictation data and/or a command from the impulse processing component.

### BACKGROUND OF THE INVENTION

The present invention generally relates to improved clinical workflow. In particular, the present invention relates to a system and method for subvocal interactions in radiology dictation and user interface (UI) commands.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

In a healthcare or clinical environment, such as a hospital, a large number of employees and patients may result in confusion or delay when trying to reach other medical personnel for examination, treatment, consultation, or referral, for example. A delay in contacting other medical personnel may result in further injury or death to a patient. Additionally, a variety of distraction in a clinical environment may frequently interrupt medical personnel or interfere with their job performance. Furthermore, workspaces, such as a radiology workspace, may become cluttered with a variety of monitors, data input devices, data storage devices, and communication device, for example. Cluttered workspaces may contribute to confusion and delays. In addition, clutter may result in inefficient workflow and service to clients, which may impact a patient's health and safety or result in liability for a healthcare facility.

Data entry and access is also complicated in a typical healthcare facility. Speech transcription or dictation is typically accomplished by typing on a keyboard, dialing a transcription service, using a microphone, using a Dictaphone, or using digital speech recognition software at a personal computer. Such dictation methods involve a healthcare practitioner sitting in front of a computer or using a telephone, which may be impractical during, for example, operational situations. Thus, management of multiple and disparate devices, positioned within an already crowded environment, that are used to perform daily tasks is difficult for medical or healthcare personnel.

In a healthcare environment involving extensive interaction with a plurality of devices, such as keyboards, computer mousing devices, imaging probes, and surgical equipment, repetitive motion disorders often occur. A system and method that eliminates some of the repetitive motion in order to minimize repetitive motion injuries would be highly desirable.

Systems utilizing speech recognition software may reduce repetitive motion disorders, but introduce other complications to, for example, data entry and dictation. For example, radiology voice dictation accuracy impacts overall medical errors. Noisy reading room environments cause interference and sub-optimal dictation accuracy. In addition, the voice training required by speech recognition software is time consuming and not always accurate. This inaccuracy is due in part to noise in the environment. Other factors including speed, microphone calibration, accent, and dialect all impact dictation accuracy.

Healthcare environments, such as hospitals or clinics, include information management systems or clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

A PACS may connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

In current information systems, such as PACS, information is entered or retrieved using a local computer terminal with a keyboard and/or mouse. During a medical procedure or at other times in a medical workflow, physical use of a keyboard, mouse or similar device may be impractical (e.g., in a different room) and/or unsanitary (i.e., a violation of the integrity of an individual's sterile field). Re-sterilizing after using a local computer terminal is often impractical for medical personnel in an operating room, for example, and may discourage medical personnel from accessing medical information systems. Thus, a system and method providing access to a medical information system without physical contact would be highly desirable to improve workflow and maintain a sterile field.

PACS are complicated to configure and to operate. Additionally, use of PACS involves training and preparation that may vary from user to user. Thus, a system and method that facilitate operation of a PACS would be highly desirable. A need exists for a system and method that improve ease of use and automation of a PACS.

Computed tomography (“CT”) exams may include images that are acquired from scanning large sections of a patients' body. For example, a chest/abdomen/pelvis CT exam includes one or more images of several different anatomy. Each anatomy may be better viewed under different window level settings, however.

During an exam interpretation process, radiologists and/or other healthcare personnel may like to note image findings as a mechanism to compose reports. In the case of structured reports, radiologists have found that the mechanism to input data is too cumbersome. That is, since there are so many possible findings related to an exam procedure, the findings need to be categorized in some hierarchy structure. The numerous hierarchical levels and choices of selection require extensive manual manipulation from the radiologist.

For example, a chest/abdomen/pelvis CT exam may include images of the liver, pancreas, stomach, etc. If a radiologist wants to input a finding related to the liver, he or she must currently traverse through a hierarchy of choices presented in the GUI before being able to identify the desired finding.

A decrease in the number of radiologists and the increase in image volume, for example 64 slice CT exams, has created exponentially more work for radiologists. Traditional methods of computer interaction (e.g., keyboard, mouse, etc.) do not address the radiologist workflow. More radiologists are suffering from repetitive stress injuries that include carpal tunnel, cubital tunnel, repetitive neck strain, and eye fatigue. Speech recognition has not demonstrated more efficiencies for this workflow due to the factors listed above.

Subvocal speech is sub-auditory, or silent, speech. When someone silently speaks or reads to themselves, biological signals are sent from the brain. This is true even when speaking or reading to oneself without actual facial movements. In effect, to use the subvocal system, a person thinks of phrases and talks to themselves so quietly others cannot hear, but the vocal cords and tongue still receive speech signals from the brain.

A subvocal speech system utilizes sensors to detect nerve impulses. The sensors may be placed near, for example, the user's jaw and/or throat. The signals may then be processed and mapped to a particular word or sound. Recognition accuracy of up to 99% has been achieved in some situations.

Therefore, there is a need for a system and method that reduces repetitive motion in order to minimize repetitive motion injuries. Further, there is a need for a system and method that operates in noisy clinical or healthcare environments. In addition, there is a need for a system and method that improves user interaction with information management systems and workflow in clinical or healthcare environments.

### BRIEF SUMMARY OF THE INVENTION

Certain embodiments of the present invention provide a medical workflow system including a subvocal input device, an impulse processing component, and an information management system. The subvocal input device is capable of sensing nerve impulses in a user. The impulse processing component is in communication with the subvocal input device. The impulse processing component is capable of interpreting nerve impulses as dictation data and/or a command. The information management system is in communication with the impulse processing component. In an embodiment, the information management system is capable of receiving dictation data and/or a command from the impulse processing component. In an embodiment, the information management system is capable of processing dictation data and/or a command from the impulse processing component. In an embodiment, the system also includes a display. The display is in communication with the information management system. The display is capable of presenting medical images from the information management system to a user. In an embodiment, the display is a touch-screen display. In an embodiment, the user selects an area of the medical image presented on the display. In an embodiment, the selected area is associated with dictation data received at the information management system. In an embodiment, the command allows selecting an area of interest in image data. In an embodiment, the dictation data is associated with an image. In an embodiment, the information management system stores dictation data received from the impulse processing component. In an embodiment, the information management system processes a command received from the impulse processing component.

Certain embodiments of the present invention provide a method for facilitating workflow in a clinical environment including acquiring nerve signal data from a subvocal sensor, associating the nerve signal data with sensor data with a nerve signal processing component, and processing sensor data with an information management system. In an embodiment, the method also includes performing speech recognition on nerve signal data. In an embodiment, the method also includes acquiring audible data spoken by a user with the subvocal sensor. In an embodiment, the method also includes performing speech recognition on audible data. In an embodiment, the associating step is based at least in part on audible data.

Certain embodiments of the present invention provide a voice command system including a subvocal processing device and an information management system. The subvocal processing device is capable of acquiring inaudible input from a user. The subvocal processing device is capable of acquiring audible input from a user. The information management system is in communication with the subvocal processing device. In an embodiment, the information management system is capable of receiving a command from the subvocal processing device. In an embodiment, the information management system is capable of processing a command from the subvocal processing device. In an embodiment, the subvocal processing device includes one or more nerve impulse sensors. In an embodiment, the command is dictation data and/or a control command. In an embodiment, the subvocal processing device generates a command based at least in part on acquired inaudible input and/or acquired audible input. In an embodiment, a command is generated based at least in part on ambient noise levels. In an embodiment, a command is generated based at least in part on speech recognition processing performed on acquired inaudible input and/or acquired audible input. In an embodiment, the information management device responds to a command from the subvocal processing device.

### BRIEF DESCRIPTION OF SEVERAL VIEWS OF THE DRAWINGS

FIG. 1 illustrates a subvocal input apparatus used in accordance with an embodiment of present invention.

FIG. 2 illustrates a medical workflow system used in accordance with an embodiment of the present invention.

FIG. 3 illustrates a voice command system used in accordance with an embodiment of the present invention.

FIG. 4 illustrates a method for facilitating workflow in a clinical environment in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

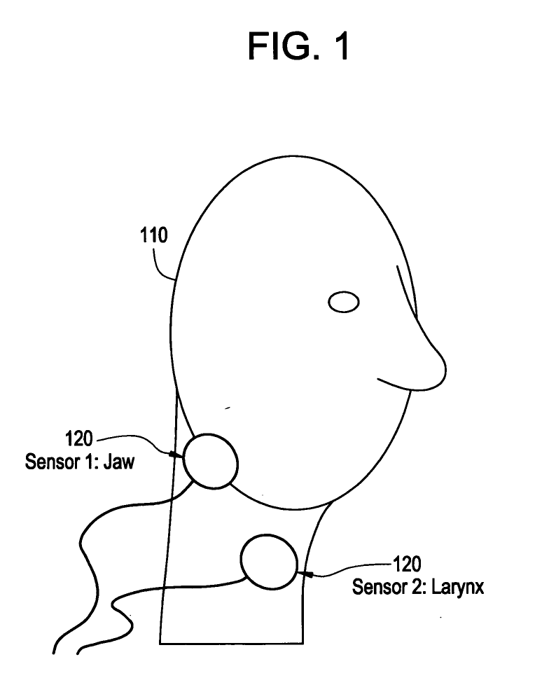

FIG. 1 illustrates a subvocal input apparatus 100 used in accordance with an embodiment of the present invention. The subvocal input apparatus 100 includes one or more sensors 120. The sensors 120 may be positioned on or near a user 110. For example, the sensors 120 may be placed on or near the jaw, tongue, throat, and/or larynx of a user 110. The sensors 120 may be electrodes. The sensors 120 may be at least one of contact sensors, dry sensors, wireless sensors, and/or capacitive sensors. The subvocal input apparatus 100 may include a processing component (not shown). The sensors 120 may be in communication with the processing component.

The sensors 120 may be capable of detecting or sensing nerve impulses in the user 110. For example, the sensors 120 may detect nerve impulses from a user's subvocal speech. The sensors 120 may be capable of generating nerve signal data. Nerve signal data may represent the sensed nerve impulses. Nerve signal data may be based at least in part on nerve impulses.

The processing component may be capable of interpreting nerve impulses detected or sensed by the sensors 120. For example, the processing component may interpret nerve impulses as dictation data and/or a command. A command may be a user interface command such as next image, previous image, zoom in, zoom out, change user, or select region, for example.

In operation, one or more sensors 120 may be positioned on or near a user 110. In an embodiment, the sensors 120 differentially capture a nerve impulse in the user 110. This impulse may be captured or sensed based on a difference in the signal received at a sensor 120 and another sensor 120, for example.

In an embodiment, the nerve impulse may be processed by transforming the impulse signal into a matrix. The matrix may be a matrix of, for example, wavelet coefficients. In an embodiment, a vector of coefficients is created using a wavelet transform. The wavelet may be a dual tree wavelet or other wavelet transform, for example.

In an embodiment, the nerve impulses and/or the matrix of coefficients may be processed with a neural-net. The neural-net may classify the input to associate the input with a particular pattern. For example, a neural-net may take as input a matrix of coefficients to associate a pattern with the signal represented by the matrix. As another example, the signal represented by the matrix may be associated with, for example, dictation data or a command. The neural-net may be trained to determine a mathematical relationship between a signal pattern and a command, word, letter, and/or dictation data, for example. A command may be a user interface command, such as zoom in, zoom out, next image, or select area, for example. With such training, the neural-net may be able to map subsequent inputs based on previously learned associations. This may allow the subvocal input apparatus 100 to correctly interpret subvocal input from a user that may not have trained the system, regardless of, for example, speed of subvocal speech, accent and/or dialect.

In an embodiment, an amplifier may be used to strengthen nerve signals. In an embodiment, signals may be processed to remove noise and/or other interference, for example. The noise may be ambient noise. The noise may be electrical and/or magnetic interference that affects, for example, the sensors 120.

Because subvocal input does not require detecting audible speech from a user, it may be used in noisy environments, such as, for example, a noisy reading room. That is, subvocal input may be less affected by ambient noise around a user. In addition, because subvocal input does not require detecting audible speech from a user, privacy may be preserved regarding the contents of the subvocal speech. For example, a physician may dictate sensitive and/or confidential information regarding a patient in a room where other activities are occurring without the risk of being overheard.

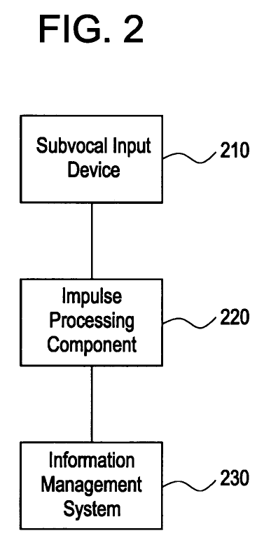

FIG. 2 illustrates a medical workflow system 200 used in accordance with an embodiment of the present invention. The system 200 includes a subvocal input device 210, an impulse processing component 220, and an information management system 230. The subvocal input device 210 is in communication with the impulse processing component 220. The information management system 230 is in communication with the impulse processing component 220. The system 200 may be integrated and/or separated in various forms, for example. The system 200 may be implemented in software, hardware, and/or firmware, for example.

The subvocal input device 210 may include, for example, a subvocal sensor. The subvocal sensor may be similar to, include, and/or be part of, for example, sensor 120 and/or subvocal input apparatus 100, described above. The subvocal input device 210 may be capable of sensing nerve impulses in a user.

The impulse processing component 220 may be capable of interpreting nerve impulses. For example, the impulse processing component 220 may be capable of receiving nerve impulse data and associating it with a command. A command may be a user interface command, for example. A user interface command may be, for example, next image, pervious image, select region, or zoom in. As another example, the impulse processing component 220 may be capable of receiving a signal or data representing one or more nerve impulses and interpreting it as dictation data. The impulse processing component 220 may be capable of processing nerve impulse data. For example, the impulse processing component 220 may perform speech recognition on nerve impulse data received from the subvocal input device 210 to associate the data with a command.

The information management system 230 may include a hospital information systems (HIS), radiology information systems (RIS), and/or picture archiving and communication systems (PACS), for example. Information stored may include patient medical histories, imaging data, test results, diagnosis information, management information, and/or scheduling information, for example. The information may be centrally stored or divided among a plurality of locations. The information management system 230 may be capable of receiving a message from, for example, the impulse processing component 220. The information management system 230 may be capable of processing a message from, for example, the impulse processing component 220. The message may be, for example, dictation data and/or a command. For example, the impulse processing component 220 may communicate dictation data to the information management system 230 for storage in a patient's medical record.

In an embodiment, the system 200 may include a display. The display may be in communication with the information management system 230. The display may be capable of presenting medical images. The medical images may be communicated from and/or stored in the information management 230, for example. For example, the display by present an x-ray image stored in a PACS. In an embodiment, the display is a touch-screen display.

In operation, the subvocal input device 210 may sense nerve impulses in a user. For example, the subvocal input device 210 may sense subvocal speech in a user based in part on subvocal sensors similar to those described above. The subvocal input device 210 may communicate nerve impulses and/or data representing nerve impulses to the impulse processing component 220.

The impulse processing component 220 may interpret nerve impulses and/or data representing nerve impulses as, for example, dictation data and/or a command. For example, the impulse processing component 220 may perform processing on nerve impulses to associate the nerve impulses with a control command. As another example, the impulse processing component 220 may perform speech recognition processing on data representing nerve impulses to interpret the impulses as dictation data and/or generate a message containing dictation data.

The information management system 230 may, for example, process, acknowledge, store, and/or respond to the command from the subvocal processing device 310. For example, the information management system 230 may store dictation data from the impulse processing component 220. As another example, the information management system 230 may process a command from the impulse processing component 220. For example, the information management system may zoom in on an image being displayed in response to a command generated when a user speaks subvocally.

In an embodiment, a user may select an area of a medical image presented on a display. For example, a user may use an input device to specify a region of an image to be selected. As another example, a user may point a portion of an image on a touch-screen display to select it. As another example, a user may subvocally speak to generate a command to select an area of interest in the image.

In an embodiment, dictation data may be associated with an image. For example, the information management system 230 may store a link or association between an image and dictation data. As another example, a radiologist may subvocally dictate comments while reading an x-ray image and have those comments associated with the image in the information management system 230 so that the comments may be accessed when another user reviews the image.

In an embodiment, a selected area of an image may be associated with, for example, dictation data. For example, when a user has selected an area or point of interest in an image (e.g., as described above) and then inputs dictation data (e.g., by speaking subvocally), the information management system 230 may associate and link the dictation data with the area of interest in the image. For example, a radiologist using an embodiment of the present invention may select a region of interest in an x-ray and then subvocally dictate notes related to that region. As another example, a user may provide dictation data and then select an area of interest to be associated with the dictation data.

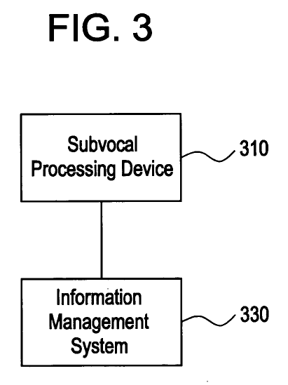

FIG. 3 illustrates a voice command system 300 used in accordance with an embodiment of the present invention. The system 300 includes a subvocal processing device 310 and an information management system 330. The information management system 330 is in communication with the subvocal processing device 310.

The subvocal processing device 310 may include, for example, a subvocal input device and/or an impulse processing component. The subvocal input device may be similar to the subvocal input device 210, described above. The impulse processing component may be similar to the impulse processing component 220, described above. The subvocal processing device 310 may include a subvocal sensor, for example. The subvocal sensor may be similar to the subvocal sensor 120, described above. The subvocal processing device 310 may include a nerve impulse sensor. The nerve impulse sensor may, for example, detect nerve impulses in a user.

The subvocal processing device 310 may be capable of acquiring inaudible input from a user. Inaudible input may include, for example, subvocal speech, as described above. The subvocal processing device 310 may be capable of acquiring audible input from a user. Audible input may include, for example, speech spoken aloud.

The information management system 330 may be similar to the information management system 230, described above. The information management system 330 may be capable of receiving a command, for example. The command may be sent by the subvocal processing device 310. The information management system 330 may be capable of processing a command, for example. For example, the information management system 330 may store dictation data received from the subvocal processing device 310.

In operation, the subvocal processing device 310 may acquire inaudible input from a user. The subvocal processing device 310 may acquire audible input from a user.

The subvocal processing device 310 may generate a command. The subvocal processing device 310 may communicate a command to the information management system 330. The command may be based at least in part on acquired inaudible input and/or acquired audible input, for example. The command may be, for example, dictation data and/or a control command. For example, the subvocal processing device 310 may generate dictation data based on audible input acquired from a user.

The information management system 330 may, for example, process, acknowledge, store, and/or respond to the command from the subvocal processing device 310. For example, the information management system 330 may store dictation data from the subvocal processing device 310.

In an embodiment, the subvocal processing device 310 may generate a command based at least in part on inaudible input and/or audible input. For example, the subvocal processing device 310 may generate a control command based at least in part on inaudible input from a user. As another example, the subvocal processing device 310 may generate dictation data based at least in part on combining and/or correlating both inaudible input and audible input.

In an embodiment, the command generated by the subvocal processing device 310 may be based at least in part on ambient noise levels. That is, when generating the command, the subvocal processing device 310 may take into account ambient noise levels. For example, ambient noise levels may be taken into account in processing the audible and/or inaudible input to generate a command. As another example, the subvocal processing device 310 may generate a command based on and/or favoring inaudible input over audible input when ambient noise levels are at a level that may introduce too much noise into the audible input.

In an embodiment, the subvocal processing device 310 may perform speech recognition processing on audible and/or inaudible input. The subvocal processing device 310 may generate a command based at least in part on speech recognition processing performed on audible and/or inaudible input. For example, the subvocal processing device may generate a dictation data command to the information management system 330 based at least in part on speech recognition processing performed on inaudible input.

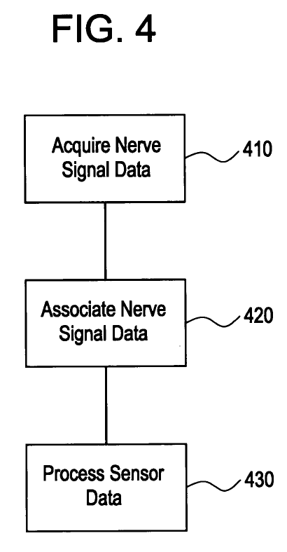

FIG. 4 illustrates a method 400 for facilitating workflow in a clinical environment in accordance with an embodiment of the present invention. The method 400 includes the following steps, which will be described below in more detail. First, at step 410, nerve signal data is acquired. Then, at step 420, nerve signal data is associated with sensor data. Next, at step 430, sensor data is processed. The method 400 is described with reference to elements of systems described above, but it should be understood that other implementations are possible.

First, at step 410, nerve signal data is acquired. Nerve signal data may be acquired from, for example, a subvocal sensor, a subvocal input apparatus, a subvocal input device, and/or a subvocal processing device 310. The subvocal sensor may be, for example, similar to a subvocal sensor 120, described above. The subvocal input apparatus may be, for example, similar to a subvocal input apparatus 100, described above. The subvocal input device may be, for example, similar to a subvocal input device 210, described above. The subvocal processing device may be, for example, similar to a subvocal processing device 310, described above. In an embodiment, the nerve signal data may be acquired from a data storage device. The data storage device may be, for example, part of an information management system, similar to an information management system 230, 330, described above.

Then, at step 420, nerve signal data is associated with sensor data. In an embodiment, a nerve signal processing component may associate nerve signal data with sensor data. The nerve signal processing component may be part of, include and/or be similar to, for example, a subvocal input device 210, an impulse processing component 220, and/or a subvocal processing device 310. Nerve signal data may be associated using, for example, a neural-net similar to neural-net described above.

Next, at step 430, sensor data is processed. Sensor data may be processed by an information management system similar to the information management system 230 or information management system 330, described above. Sensor data may be processed by a neural-net, similar to the neural-net described above, for example. In an embodiment, processing may include performing speech recognition on sensor data. For example, voice recognition software may be used to convert sensor data into dictation data and/or a command.

In an embodiment, speech recognition is performed on nerve signal data. For example, voice recognition software may be used to convert nerve signal data into dictation data and/or a command.

In an embodiment, audible data spoken by a user is acquired. The audible data may be acquired using, for example, a subvocal input device 210, subvocal processing device 310, or subvocal sensor 120. The subvocal input device, subvocal processing device, or sensor may include a microphone, for example, to acquire audible data.

In an embodiment, speech recognition may be performed on audible data. For example, voice recognition software may be used to audible data into dictation data and/or a command.

In an embodiment, nerve signal data may be associated with sensor data based at least in part on audible data. For example, audible data may provide additional contextual information to aid the association of nerve signal data with sensor data. For example, noise in the acquisition of nerve signal data may reduce the accuracy of the association of the nerve signal data to sensor data. However, audible data acquired from a user in addition to the nerve signal data may allow the nerve signal data to be properly associated with sensor data.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide a system and method that reduce repetitive motion in order to minimize repetitive motion injuries. Certain embodiments of the present invention provide a system and method that operate in noisy clinical or healthcare environments. Certain embodiments of the present invention improve user interaction with information management systems and workflow in clinical or healthcare environments.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A medical workflow system, the system including:
a subvocal input device, the subvocal input device capable of sensing nerve impulses in a user;
an impulse processing component, the impulse processing component in communication with the subvocal input device, the impulse processing component capable of interpreting the nerve impulses as at least one of dictation data and a command; and
an information management system, the information management system in communication with the impulse processing component, the information management system capable of processing at least one of the dictation data and the command from the impulse processing component.

2. The system of claim 1, further including a display, the display in communication with the information management system, the display capable of presenting medical images from the information management system to the user.

3. The system of claim 2, wherein the display is a touch-screen display.

4. The system of claim 2, wherein the user selects an area of the medical image presented on the display.

5. The system of claim 4, wherein the selected area is associated with dictation data received at the information management system.

6. The system of claim 1, wherein the command allows selecting an area of interest in image data.

7. The system of claim 1, wherein the dictation data is associated with an image.

8. The system of claim 1, wherein the information management system stores dictation data received from the impulse processing component.

9. The system of claim 1, wherein the information management system processes the command received from the impulse processing component.

10. A method for facilitating workflow in a clinical environment, said method including:
acquiring nerve signal data from a subvocal sensor;
associating the nerve signal data with sensor data with a nerve signal processing component; and
processing sensor data with an information management system.

11. The method of claim 10, further including performing speech recognition on the nerve signal data.

12. The method of claim 10, further including acquiring audible data spoken by a user with the subvocal sensor.

13. The method of claim 12, further including performing speech recognition on the audible data.

14. The method of claim 12, wherein the associating step is based at least in part on the audible data.

15. A voice command system, said system including:
a subvocal processing device, the subvocal processing device capable of acquiring inaudible input from a user, the subvocal processing device capable of acquiring audible input from the user; and
an information management system, the information management system in communication with the subvocal processing device, the information management system capable of processing a command from the subvocal processing device.

16. The system of claim 15, wherein the subvocal processing device includes one or more nerve impulse sensors.

17. The system of claim 15, wherein the command is at least one of dictation data and a control command.

18. The system of claim 15, wherein the subvocal processing device generates the command based at least in part on at least one of acquired inaudible input and acquired audible input.

19. The system of claim 18, wherein the command is generated based at least in part on ambient noise levels.

20. The system of claim 18, wherein the command is generated based at least in part on speech recognition processing performed on at least one of acquired inaudible input and acquired audible input.
